(19) United States
(12) Patent Application Publication
(10) Pub. No.: US 2013/0139769 A1
(43) Pub. Date: Jun. 6, 2013

(54) Mackay Tri-expansion cycle engine utilizing an eight-stroke master cylinder and an eight-stroke slave cylinder

(71) Applicant: Lung Tan Hu, Langley (CA)

(72) Inventor: Lung Tan Hu, Langley (CA)

(21) Appl. No.: 13/373,884

(22) Filed: Dec. 5, 2011

(51) Int. Cl. F02B 75/20

(52) U.S. Cl. 123/58.8

(57) ABSTRACT

The present invention provides a Mackay tri-expansion cycle engine which operates with an eight-stroke master cylinder and an eight-stroke slave cylinder; the Mackay tri-expansion cycle engine intakes air and fuel into the eight-stroke master cylinder, and the air-fuel-mixture combusts in three expansion processes; the first expansion process generates power at high temperature with a hot-combustion-medium of high CO concentration; the second expansion process generates power with a cold-expansion-medium mixing from said hot-combustion-medium and a compressed air, spontaneously converting all CO content into CO₂ at a controlled expansion temperature; the third expansion process generates power with a steam-rich expansion-medium at a controlled expansion temperature, in which a calculated amount of water-mixture is injected to absorb heat energy and produce steam, at same time reacting with any remained NO_{X}, HC, and PM to reduce air-pollution from combustion process.

### FIELD OF THE INVENTION

The present invention relates to a further developed eight-stroke cycle engine operating in Mackay Tri-expansion Cycle, which can reduce the emissions of HC, NO_{X}, and PM of the eight-stroke cycle engine and maintain a high thermal efficiency, the Mackay tri-expansion cycle engine can be used in the fields of transportation and power generation for reducing the air pollution.

### BACKGROUND OF THE INVENTION

The present invention is a continuing research project of the eight-stroke cycle engine, which focuses on reducing heat loss and air-pollution by the means of second expansion; the eight-stroke cycle engine is introduced in the U.S. Pat. No. 6,918,358 (Eight-stroke internal combustion engine utilizing a slave cylinder, filed on Jul. 15, 2003 by Hu Lung Tan), and a prototype of the eight-stroke cycle is completed at the year of 2004, which achieves an efficiency of 48% and a zero emission of CO at the exhaust port of the slave cylinder, showing that the eight-stroke cycle can completely convert all CO to CO₂ before the exhaust gas is expelled out of the engine; however, the incoming international emission standards are also increasingly demanding, a much lower emission level of NO_{X}, HC, CO, and PM is required in the future, therefore, the present invention is hereby providing a further improved solution.

### SUMMARY OF THE INVENTION

It is the main objective of the present invention to provide a Mackay Tri-expansion Cycle Engine (MTCE) that is capable of performing a hot-combustion-process, a cold-expansion-process, and a steam-expansion-process at a high thermal efficiency.

It is the second objective of the present invention to provide a Mackay Tri-expansion Cycle Engine that is capable of reducing air pollution by producing less HC, NO_{X}, and PM in the exhaust gas.

### BRIEF DESCRIPTION OF THE DRAWINGS

FIG. 1A shows the first embodiment of the Mackay Tri-expansion Cycle Engine.

FIG. 1B shows an alternative form of the first embodiment.

FIG. 2 shows a pressure-volume chart of the Mackay Tri-expansion Cycle.

### DETAILED DESCRIPTION OF THE PREFERRED EMBODIMENTS

The present invention is a continuing research project of the eight-stroke cycle engine, disclosed in the U.S. Pat. No. 6,918,358 (Eight-stroke internal combustion engine utilizing a slave cylinder, filed on Jul. 15, 2003 by Hu Lung Tan), in which an eight-stroke cycle consisting of two compressing processes and two expansion processes is introduced for controlling the expansion pressure and expansion temperature of the air-fuel-mixture; the first expansion process, called the hot-combustion-process, is combusting the air-fuel-mixture at high temperature into a hot-combustion-medium, in which the carbon-monoxide is not converted into carbon-dioxide due to the high temperature expansion; the second expansion process, called the cold-expansion-process, is to mix the hot-combustion-medium with a compressed air to form a cold-expansion-medium, in which the carbon-monoxide is instantly cooled and the oxygen content of the compressed-air accelerates the conversion from carbon-monoxide to carbon-dioxide, thereby achieving a complete combustion at a low temperature before the cold-expansion-medium expands to the maximum cylinder volume, thereby greatly reducing heat loss from the master cylinder and the slave cylinder and sustaining a relatively high and stable expansion pressure than conventional internal combustion engines.

The present invention is a further developed expansion cycle, named Mackay Tri-expansion Cycle, which consists of two compression processes, three expansion processes, and one exhaust process.

The basic structure of the present invention is constructed with an eight-stroke master cylinder (master cylinder) and an eight-stroke slave cylinder (slave cylinder); the eight-stroke master cylinder includes a master-piston which operates in a cycle of a master-intake-stroke, a master-compression-stroke, a master-expansion-stroke, a master-exhaust-stroke; the eight-stroke slave cylinder includes a slave-piston which operates in a cycle of a slave-intake-stroke, a slave-compression-stroke, a slave-expansion-stroke, a slave-exhaust-stroke; the slave-piston trails the master-piston by a trailing angle of 35 degree to 120 degree; for the purpose of better performance, the trailing angle between the master-piston and the slave-piston can be adjusted in said range of 35-120 degree during the operation of Mackay Tri-expansion Cycle Engine, adapting to the load condition for optimizing thermal efficiency.

As a supplementary explanation for the trailing angle, the following examples are provided: the slave piston is at the TDC position of the slave-intake-stroke when the master piston is at 40 degree of the master-intake-stroke if the trailing angle is set to 40 degree; the slave piston is at the TDC position of the slave-intake-stroke when the master piston is at 120 degree of the master-intake-stroke if the trailing angle is set to 120 degree.

In an embodiment utilizing a gasoline ignition system, the eight-stroke master cylinder takes in an air and a fuel during the master-intake-stroke, the eight-stroke master cylinder compresses said air and fuel during the master-compression-stroke, next, said air and fuel ignites at about the end of the master compression-stroke to produce a hot-combustion-medium, at the same time the eight-stroke slave cylinder is compressing the air at an increasing pressure; next, at the point that the hot-combustion-medium is expanding to a condition that the pressure of the hot-combustion-medium is lower than the pressure of the compressed air of the eight-stroke slave cylinder, the compressed air is injected into the eight-stroke master cylinder through an air-injection-valve, forming a cold-expansion-medium in the eight-stroke master cylinder; next, at the point when the cold-expansion-medium is formed and most of the carbon-monoxide is converted into a carbon-dioxide, a coordinate-channel (a controlled air-passage between the master cylinder and the slave cylinder) is effected to draw the cold-expansion-medium into the eight-stroke slave cylinder, so the cold-expansion-medium starts to expand in both the eight-stroke master cylinder and the eight-stroke slave cylinder, generating power to both the master piston and the slave piston; next, when the cold-expansion-medium is flowing towards the eight-stroke slave cylinder, a high pressure water-mixture injector, disposed in the coordinate-channel or in the eight-stroke slave cylinder, injects a calculated amount of water or water-mixture to mix with the cold-expansion-medium, so the water absorbs heat energy from the cold-expansion-medium and evaporates into steam, forming a steam-expansion-medium that sustains the expansion pressure and further reduces any remained NO_{X}, HC, and PM of the cold-expansion-medium; next, at the point when the steam-expansion-medium expands to about 70%-100% of the maximum combined volume of the eight-stroke master cylinder and the eight-stroke slave cylinder, a slave-exhaust-valve is opened to expel the steam-expansion-medium; for the purpose of reducing pumping loss, an optional master-exhaust-valve, disposed in the eight-stroke master cylinder, may be used to directly exhaust the steam-expansion-medium out of the eight-stroke master cylinder during the master-exhaust-stroke.

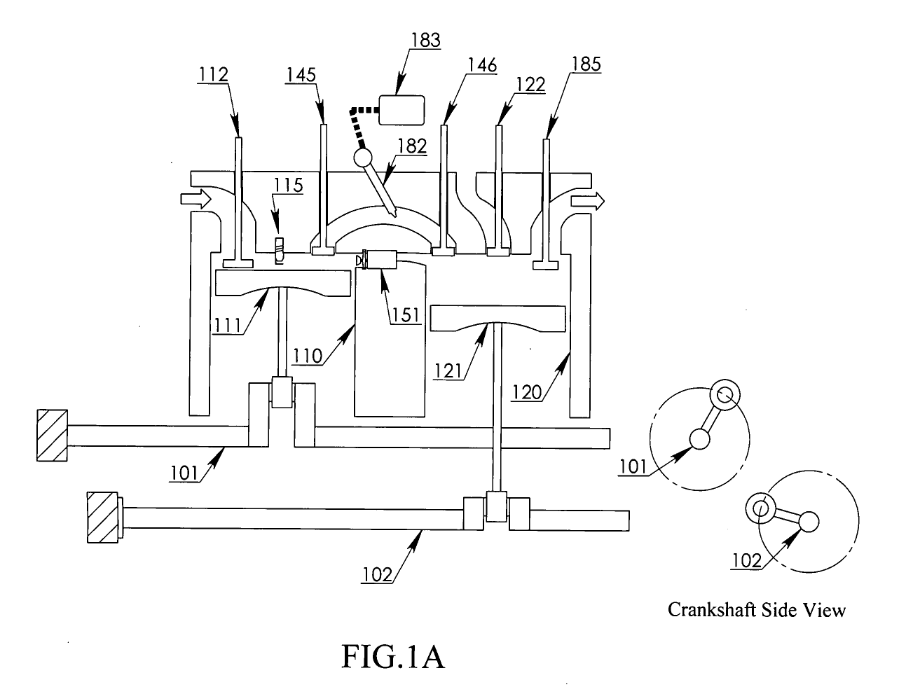

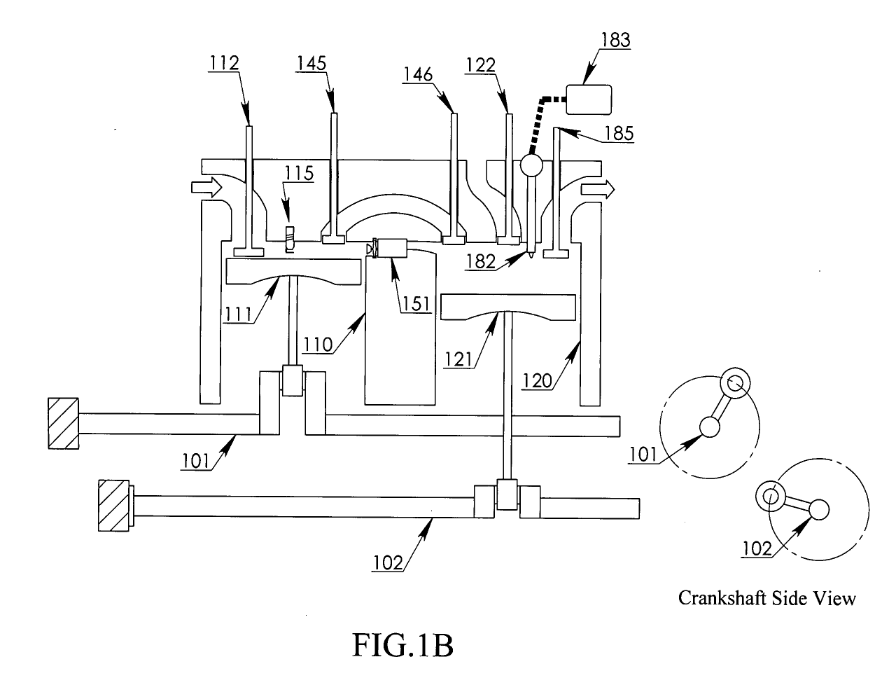

In the first embodiment shown in FIG. 1A, the components are labeled as the master cylinder 110, the slave cylinder 120, the master piston 111, the slave piston 121, the coordinate-channel inlet valve 145, the coordinate-channel outlet valve 146, the air-injection-valve 151, the master-intake-valve 112, the slave-intake-valve 122, the slave-exhaust-valve 185, the high pressure water-mixture injector 182, the water-reservoir 183, the master crankshaft 101, the slave crankshaft 102, the spark-plug 115.

Another alternative form of the first embodiment is shown in FIG. 1B, the components are labeled as the master cylinder 110, the slave cylinder 120, the master piston 111, the slave piston 121, the coordinate-channel inlet valve 145, the coordinate-channel outlet valve 146, the air-injection-valve 151, the master-intake-valve 112, the slave-intake-valve 122, the slave-exhaust-valve 185, the high pressure water-mixture injector 182, the water-reservoir 183, the master crankshaft 101, the slave crankshaft 102, the spark-plug 115, wherein the high pressure water-mixture injector 182 is disposed in the slave cylinder 120, instead of the coordinate-channel.

For better comprehension of the Mackay Tri-expansion Cycle Engine utilizing an eight-stroke master cylinder and an eight-stroke slave cylinder, the cycle is explained in ten processes, which are the master-intake-process, the slave-intake-process, the master-compression-process, the slave-compression-process, the hot-combustion-process, the air-injection-process, the cold-expansion-process, the fluid-injection-process, the steam-expansion-process, the exhaust-process, wherein:

1. The master-intake-process is performed mostly during the master-intake-stroke, and this process provides air and fuel into the eight-stroke master cylinder; when used with a gasoline-direct-injection fuel supplying system or a diesel-direct-injection system, the fuel is commonly supplied during the master-compression-stroke (a conventional carburetor may also be used to supply fuel).

2. The slave-intake-process is performed mostly during the slave-intake-stroke, and this process provides an air which is later compressed and injected to the eight-stroke master cylinder.

3. The master-compression-process is performed during the master-compression-stroke, and this process compresses an air-fuel-mixture (or air only in a GDI fuel system or a CIDI fuel system) in the eight-stroke master cylinder.

4. The slave-compression-process is performed during the earlier half of the slave-compression-stroke, and this process raises the pressure of compressed-air of the eight-stroke slave cylinder until the pressure of compressed-air is high enough to be injected into the eight-stroke master cylinder.

5. The hot-combustion-process is started at about the end of the master-compression-stroke, and this process combusts most of the fuel at high temperature, forming a hot-combustion-medium in the eight-stroke master cylinder, in which most CO cannot be converted to CO₂ due to high temperature.

6. The air-injection-process is performed during the later half of the slave-compression-stroke, and this process injects a high pressure compressed-air, through an air-injection-valve, to mix with the hot-combustion-medium, thereby cooling both the hot-combustion-medium and the eight-stroke master cylinder, and this cooling effect reduces the heat loss of the master cylinder and increases maximum power output of the eight-stroke master cylinder by preventing engine knocking.

7. The cold-expansion-process is performed in the eight-stroke master cylinder after the completion of the air-injection-process, and this process spontaneously converts most CO to CO₂ due to the instant cooling and the addition of the extra oxygen from the compressed-air, resulting in an air-rich cold-expansion medium that can accelerate a completed combustion of air-fuel mixture, during this process the expansion temperature should be regulated within a range of 1200-750 degree Celsius for optimal thermal efficiency.

8. The fluid-injection-process is performed by a high pressure water-mixture injector, disposed in the coordinate-channel or in the eight-stroke slave cylinder, and this high pressure water-mixture injector injects water or a blend of mostly water and few lubrication additives, so the injected water absorbs heat energy and instantly evaporates to steam, forming a steam-expansion-medium and also reducing any existing HC, NO_{X}, and PM to less pollutant substances, wherein the amount of the water being injected is adjusted according to the engine load condition or to a sensor that can detect the steam-saturation level in the exhaust gas, thereby preventing condensation in either cylinders; it should be noted that the water-mixture should only be mixed with the cold-expansion-medium after most of CO is converted into CO₂ to prevent energy loss from water condensation.

9. The steam-expansion-process is performed after the completion of the fluid-injection-process; the steam-expansion-medium continues to expand in both the eight-stroke master cylinder and the eight-stroke slave cylinder at a temperature within the range of 900-400 degree Celsius, efficiently generating power to both the master-piston and the slave-piston.

10. The exhaust-process process is performed by a slave-exhaust-valve to expel the steam-expansion-medium out of the eight-stroke slave cylinder at a point after the volume of the steam-expansion-medium has substantially reached about 70% of the maximum combined volume of the eight-stroke master cylinder and the eight-stroke slave cylinder; this process is performed mostly during the slave-exhaust-stroke, and an optional master-exhaust-valve may be used to expel the steam-expansion-medium out of the eight-stroke master cylinder to reduce pumping loss.

Due to the mechanical structure of the high pressure water-mixture injector, the fluid-injection-process may be partially overlapped with the cold-expansion-process, this is because the current high pressure water-mixture injector is not capable of forcing sufficient water-mixture through the injector at high rpm, therefore, the actuation of the water-mixture injector is preferably to begin at a point between 15 degree before the TDC of the slave-piston and 50 degree after the TDC of the slave-piston.

During the steam-expansion-process, the steam-vapor may exist in both the eight-stroke master cylinder and the eight-stroke slave cylinder depending on the engine speed and the installed position of the high-pressure water-mixture injector.

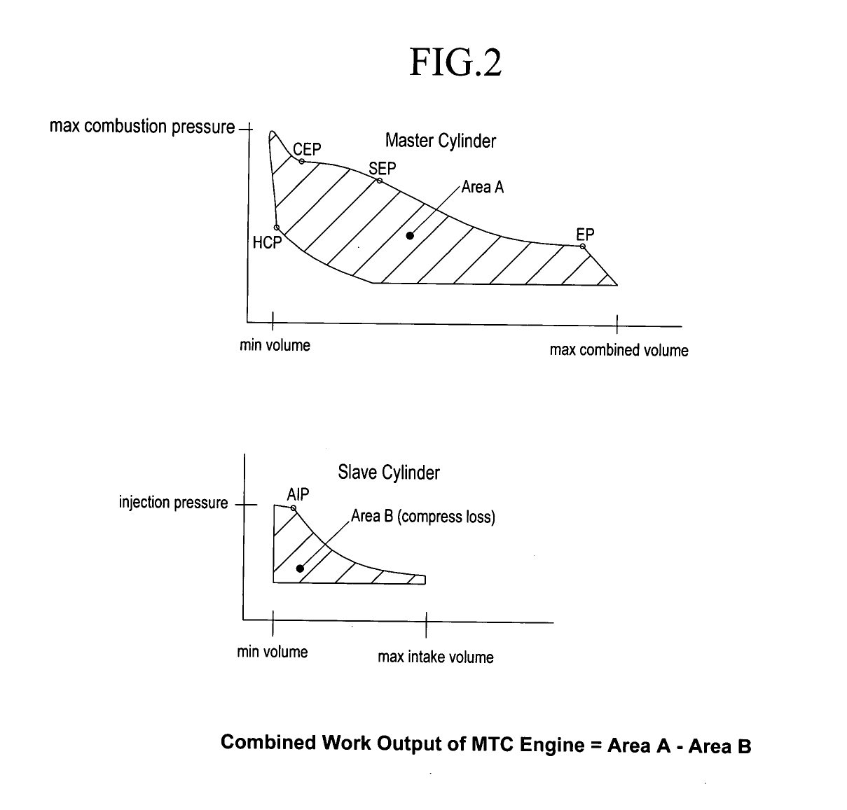

FIG. 2 shows a pressure-volume chart for demonstrating the relationship between the work output and the compression loss, wherein the hot-combustion-process (HCP), the cold-expansion-process (CEP), the steam-expansion-process (SEP), and the exhaust-process (EP) are marked to demonstrate the effect of three expansion processes; at the beginning of the hot-combustion-process, the combustion pressure raise to a peak pressure value, and then the combustion pressure drops to a pressure value lower than compression pressure of the slave cylinder, and then the air-injection-process is started by forcing the compressed-air into the master cylinder, which sustains the expansion pressure (combustion pressure) in the master cylinder, it can be seen that the pressure curve from the point of CEP to the point of SEP are decreasing much slower than that of the conventional four-stroke engine; next, at the point where most of CO has converted spontaneously into CO₂, the fluid-injection-process is started by injecting a calculated amount of water or water-mixture; and next, the steam-expansion-process is immediately started by evaporating the injected water, as the density of the cold-expansion-medium is increased by the addition of steam, forming a steam-expansion-medium, it can be seen that the pressure curve is still decreasing much slower than that of the four-stroke engine, meaning that the expansion-pressure of the MTCE lasts at a higher pressure than the conventional engine, and a higher fraction of thermal energy is converted into power; furthermore, the temperatures of the cold-expansion-medium and the steam-expansion-medium (from the point of CEP to the point of EP) are much lower than the temperature of the combusting-medium of the conventional engine, meaning that less heat is dissipated in the cooling circulation system of the MTCE, so a higher thermal efficiency is expected in most conditions.

As seen in FIG. 2, the combined work output, or the actual power output, of the Mackay Tri-expansion Cycle engine can be calculated by subtracting the Area A with the Area B; wherein the Area A is the expansion power output minus the compression loss of the master cylinder, the Area B is the compression loss of the slave cylinder.

Due to the low temperature characteristics of said three expansion processes, the eight-stroke slave cylinder may be constructed as a heat insulated cylinder to further prevent heat loss, thereby gaining a higher overall pressure throughout the cold-expansion-process and the steam-expansion-process for better thermal efficiency.

Mackay Tri-expansion Cycle Engine can run on diesel, gasoline, bio-fuel, ethanol, natural gas, syngas, or any other conventional fuel; while the fuel supplying system and the ignition system may vary due to the different fuel type, possible fuel supplying system are carburetors, high pressure fuel injectors, port fuel injectors, natural gas injectors, or any other conventional fuel supplying system; the possible ignition system are spark ignition system, compression-ignition diesel injection system, or any other conventional ignition system.

1. A Mackay Tri-expansion Cycle Engine utilizing an eight-stroke master cylinder and an eight-stroke slave cylinder including:
a) a set of one eight-stroke master cylinder and one eight-stroke slave cylinder; wherein each eight-stroke master cylinder includes a master-piston which operates in a cycle of a master-intake-stroke, a master-compression-stroke, a master-expansion-stroke, a master-exhaust-stroke; each eight-stroke slave cylinder includes a slave-piston which operates in a cycle of a slave-intake-stroke, a slave-compression-stroke, a slave-expansion-stroke, a slave-exhaust-stroke; the slave-piston trails the master-piston by a trailing angle of 35 degree to 120 degree;
b) an air-supplying means and a fuel-supplying means and an ignition means for initiating a combustion in each eight-stroke master cylinder, thereby forming a hot-combustion-medium at about the end of the master-compression-stroke;
c) an air-supplying means for providing air to each eight-stroke slave cylinder;
d) an exhaust means for expelling exhaust-gas from each eight-stroke slave cylinder;
e) an air-passage and a valve means for injecting all compressed gas from each eight-stroke slave cylinder to the corresponding eight-stroke master cylinder when the compression pressure of the eight-stroke slave cylinder is higher than the combustion pressure of the hot-combustion-medium, thereby forming a cold-expansion-medium in the eight-stroke master cylinder;
f) an air-passage and a valve means for transferring the cold-expansion-medium from each eight-stroke master cylinder to the corresponding eight-stroke slave cylinder through the slave-expansion-stroke;
g) a high-pressure water-mixture injector for injecting a calculated amount of water or water-mixture into the eight-stroke slave cylinder for mixing with said transferred cold-expansion-medium, thereby forming a steam-expansion-medium in the eight-stroke slave cylinder;
h) and an engine-control-unit for controlling all said air-supplying means, valve means, fuel-supplying means, and high-pressure water-mixture injector, wherein:
the temperature of said cold-expansion-medium is regulated within a range of 1200-750 degree Celsius, by adjusting the amount of the compress-air of the eight-stroke slave-cylinder, for reducing heat loss of the eight-stroke master cylinder;
and the temperature of said steam-expansion-medium is regulated within a range of 900-400 degree Celsius, by adjusting the amount of the water-mixture provided by the high-pressure water-mixture injector, for increasing power output of the eight-stroke slave cylinder and further reducing heat loss of the eight-stroke slave cylinder.

2. A Mackay Tri-expansion Cycle Engine utilizing an eight-stroke master cylinder and an eight-stroke slave cylinder as defined in claim 1, wherein; said engine-control-unit sustains a high thermal efficiency by controlling said air-supplying means and fuel supplying means such that a fuel-rich air-fuel-mixture is formed at about the end of the master-compression-stroke, which generates a hot-combustion-medium that contains a high concentration of CO at about 2400-1800 degree Celsius, and a controlled amount of compressed-air is injected into said hot-combustion-medium to spontaneously convert all CO to CO₂ at a temperature below 1200 degree Celsius, thereby forming a cold-expansion-medium in the eight-stroke master cylinder.

3. A Mackay Tri-expansion Cycle Engine utilizing an eight-stroke master cylinder and an eight-stroke slave cylinder as defined in claim 2, wherein; said engine-control-unit sustains a high thermal efficiency by controlling the amount of the injected water-mixture from said high-pressure water-mixture injector, such that the temperature of the steam-expansion-medium is maintained at higher than 400 degree Celsius, thereby preventing any condensation of water-mixture in the eight-stroke slave cylinder during the slave-expansion-stroke.

4. A Mackay Tri-expansion Cycle Engine utilizing an eight-stroke master cylinder and an eight-stroke slave cylinder as defined in claim 3, wherein; said high-pressure water-mixture injector is preferably being actuated between 15 degree prior to the TDC of the slave piston and 50 degree after the TDC of the slave piston.

5. A Mackay Tri-expansion Cycle Engine utilizing an eight-stroke master cylinder and an eight-stroke slave cylinder including:
a) a set of one eight-stroke master cylinder and one eight-stroke slave cylinder; wherein, each eight-stroke master cylinder includes a master-piston, each eight-stroke slave cylinder includes a slave-piston, and the slave-piston trails the master-piston by a trailing angle of 35 degree to 120 degree;
b) an air-supplying means and a fuel-supplying means and an ignition means for initiating a fuel-rich combustion in each eight-stroke master cylinder, thereby forming a hot-combustion-medium;
c) an air-supplying means for providing air to each eight-stroke slave cylinder;
d) an exhaust means for expelling exhaust-gas from each eight-stroke slave cylinder;
e) an air-passage and a valve means for injecting all compressed gas from each eight-stroke slave cylinder to the corresponding eight-stroke master cylinder when the compression pressure of the eight-stroke slave cylinder is higher than the combustion pressure of the hot-combustion-medium, thereby forming a cold-expansion-medium at a temperature between 1200 degree Celsius and 750 degree Celsius in the eight-stroke master cylinder;
f) an air-passage and a valve means for transferring the cold-expansion-medium from each eight-stroke master cylinder to the corresponding eight-stroke slave cylinder;
g) a high-pressure water-mixture injector for injecting a calculated amount of water or water-mixture into the cold-expansion-medium, thereby forming a steam-expansion-medium at a temperature between 900 degree Celsius and 400 degree Celsius.

6. A Mackay Tri-expansion Cycle Engine utilizing an eight-stroke master cylinder and an eight-stroke slave cylinder as defined in claim 5 further includes an exhaust means for expelling exhaust gas from said eight-stroke master cylinder.

7. A Mackay Tri-expansion Cycle Engine utilizing an eight-stroke master cylinder and an eight-stroke slave cylinder as defined in claim 6, wherein; said amount of water-mixture injected by the high-pressure water-mixture injector is adjusted according to both the engine load condition and the temperature of the exhaust gas, such that the steam-expansion-medium is maintained at an optimal expansion temperature, predetermined by an engine control unit.

8. A Mackay Tri-expansion Cycle Engine utilizing an eight-stroke master cylinder and an eight-stroke slave cylinder including:
a) a set of one eight-stroke master cylinder and one eight-stroke slave cylinder; wherein, each eight-stroke master cylinder includes a master-piston, each eight-stroke slave cylinder includes a slave-piston;
b) an air-supplying means and a fuel-supplying means and an ignition means for initiating a combustion in each eight-stroke master cylinder;
c) an air-supplying means for providing air to each eight-stroke slave cylinder;
d) an exhaust means for expelling exhaust-gas from each eight-stroke slave cylinder and each eight-stroke master cylinder;
e) an air-passage and a valve means for injecting all compressed gas from each eight-stroke slave cylinder to the corresponding eight-stroke master cylinder when the compression pressure of the eight-stroke slave cylinder is higher than the combustion pressure of the eight-stroke master cylinder;
f) an air-passage and a valve means for transferring a cold-expansion-medium from each eight-stroke master cylinder to the corresponding eight-stroke slave cylinder;
g) a high-pressure water-mixture injector for injecting a calculated amount of water or water-mixture into the cold-expansion-medium, thereby forming a steam-expansion-medium;
h) and an engine control unit for operating said Mackay Tri-expansion Cycle Engine in a cycle consisting of ten processes, said cycle operates in the order of a master-intake-process, a slave-intake-process, a master-compression-process, a slave-compression-process, a hot-combustion-process, an air-injection-process, a cold-expansion-process, a fluid-injection-process, a steam-expansion-process, and an exhaust-process.

9. A Mackay Tri-expansion Cycle Engine utilizing an eight-stroke master cylinder and an eight-stroke slave cylinder as defined in claim 8, wherein; said hot-combustion-process produces power with a fuel-rich expansion-medium in the eight-stroke master cylinder, said cold-expansion-process produces power with an air-rich expansion-medium in both the eight-stroke master cylinder and the eight-stroke slave cylinder, said steam-expansion-process produces power with a steam-rich expansion-medium in both the eight-stroke master cylinder and the eight-stroke slave cylinder.

10. A Mackay Tri-expansion Cycle Engine utilizing an eight-stroke master cylinder and an eight-stroke slave cylinder as defined in claim 9, wherein; the temperature of said air-rich expansion-medium is preferably maintained within a temperature range of 1200-750 degree Celsius during the cold-expansion-process, and the temperature of said steam-rich expansion-medium is preferably maintained within a temperature range of 900-400 degree Celsius during the steam-expansion-process.

11. A Mackay Tri-expansion Cycle Engine utilizing an eight-stroke master cylinder and an eight-stroke slave cylinder as defined in claim 10, wherein, the fluid-injection-process begins at a point between 15 degree before the TDC of the slave-piston and 50 degree after the TDC of the slave-piston.

12. A Mackay Tri-expansion Cycle Engine utilizing an eight-stroke master cylinder and an eight-stroke slave cylinder as defined in claim 11, wherein, said slave-piston trails the master-piston by at trailing angle of 35-120 degree of crankshaft angle, and said trailing angle may be adjusted with an adjustable coupling during the operation of said Mackay Tri-expansion Cycle Engine for optimizing the thermal efficiency in different load conditions.
